(19) United States
(12) Patent Application Publication
(10) Pub. No.: US 2007/0044912 A1
(43) Pub. Date: Mar. 1, 2007

(54) Method for the production of a partially metallized carrier substrate

(76) Inventors: Stephan Trassl, Kemnath (DE); Peter Reich, Pirk (DE)

Correspondence Address: WENDEROTH, LIND & PONACK, L.L.P., 2033 K STREET N. W., SUITE 800, WASHINGTON, DC, 20006-1021, US

(21) Appl. No.: 11/482,907

(22) Filed: Jul. 10, 2006

(30) Foreign Application Priority Data
Jul. 19, 2005 (EP) 05 015 612.2

(51) Int. Cl. B29C 63/00

(52) U.S. Cl. 156/344

(57) ABSTRACT

Method for the production of a metallized carrier substrate, characterized in that a) in a first step in a digital printing method a printing ink with melt-on capability is partially applied onto a carrier substrate, b) in a second step metallization of the carrier substrate over the entire surface takes place, c) in a third step the carrier substrate is heated, wherein the printing ink with melt-on capability applied in the first step is melted, whereupon d) in a fourth step the printing ink, which is now liquid, together with the superjacent metal layer is removed through mechanical action or by means of ultrasonic treatment.

The invention relates to a method for the production of a partially metallized carrier substrate.

After having optionally been correspondingly cut to size, partially metallized carrier substrates are utilized as security elements, in particular in security documents and bank note paper, data media, packagings and the like, but also as decorative element.

EP 1 291 463 discloses a method for the production of a selectively metallized sheet, where in a first step on a carrier substrate on one or both sides of the carrier substrate a color application soluble in a solvent is applied, in a second step this layer is treated by means of an inline plasma, corona or flame process, and in a third step a layer of a material to be structured is applied. This layer may be comprised of metals, metal compounds, alloys or insulators, whereupon in a fourth step the color application is removed by means of a solvent, optionally combined with mechanical action.

WO 99/131/57 discloses security sheets for bank note paper, in which on a translucent sheet a metal coating is applied, which in the finished sheet is not applied over the entire area but rather has coat-free zones, which are said to be clearly recognizable under transmitted light. The production of these sheets takes place thereby that a carrier sheet is imprinted with a highly pigmented printing ink, wherein the color application is not carried out over the entire area, the printing ink is dried with the formation of a porous coat, a metal cover layer is subsequently applied and in a further step the highly pigmented printing ink is removed by rinsing with a solvent, optionally also under mechanical action. Therewith, in those regions, in which the printing ink is removed, the metal cover layer is also removed, whereby the open-area clearances, recognizable under transmitted light, are formed. The metallic cover layer has a thickness of 0.01 to 1 μm.

EP 0 536 855 B2 discloses a method for the production of a partially metallized strip, in which either by hot stamping or utilizing a mask in the vacuum metallization or through partial chemical etching the corresponding metallization is produced.

Individualization of the partial metallization is not provided and can only take place in a further method step, for example by means of laser treatment, in which the metallization is removed selectively.

The invention therefore addresses the problem of providing a method for the production of a partially metallized carrier substrate, in which in simple manner individualized partial metallization can be produced directly.

Subject matter of the invention is therefore a method for the production of a metallized carrier substrate, characterized in that
a) in a first step in a digital printing method a printing ink with melt-on capability is partially applied onto a carrier substrate,
b) in a second step metallization of the carrier substrate over the entire surface takes place,
c) in a third step the carrier substrate is heated, wherein the printing ink with melt-on capability applied in the first step is melted, whereupon
d) in a fourth step the printing ink, which is now liquid, together with the superjacent metal layer is removed through mechanical action or by means of ultrasonic treatment.

As the carrier substrates can be utilized for example carrier sheets, preferably flexible transparent synthetic material sheets, comprised for example of PI, PP, MOPP, PE, PPS, PEEK, PEK, PEI, PAEK, LCP, PEN, PBT, PET, PA, PC, COC, POM, ABS and PVC.

The carrier sheets have preferably a thickness of 5-700 μm, preferred is a thickness of 5-200 μm, and especially preferred is a thickness of 5-50 μm.

As the carrier substrate can further also serve metal sheets, for example Al-, Cu-, Sn-, Ni-, Fe- or special steel sheets having a thickness of 5-200 μm, preferably 10 to 80 μm, especially preferred 20-50 μm. The sheets may also be surface-treated, coated or laminated, for example with synthetic material or they may be varnished.

Further as carrier substrates can also be utilized paper or composites with paper, for example composites with synthetic materials with a weight per unit area of 20-500 g/m², preferably 40-200 g/m².

As carrier substrates can further be utilized woven or non-woven textiles, such as non-woven continuous filament textiles, non-woven staple fiber textiles and the like, which optionally may be needled and/or calendered. Such woven or non-woven textiles are preferably comprised of synthetic materials, such as PP, PET, PA, PPS and the like. However, it is also feasible to utilize woven or non-woven textiles comprised of natural, optionally treated, fibers, such as viscose fibers. The utilized non-woven or woven textiles have a weight per unit area, for example, of 20 g/m² to 500 g/m². The woven or non-woven textiles must optionally be surface-treated.

By means of a digital printing method, onto the carrier substrate is subsequently partially applied a digital printing ink with the capability of being melted on in the form of the desired subsequent open-area clearances in the metallic layer.

A transparent printing ink can preferably be used, with the use of which it is avoided that possible remainders of the printing ink are visible at the margin of the open-area clearances. Therein preferably a digital printing ink is utilized, which melts at for example 90 to 160° C., preferably 100-120° C. The application of the printing ink can preferably take place such that it is individualized.

Application of the digital printing ink can be individualized and can be applied in the form of patterns, lines, geometric figures, symbols, letters, numbers, in the form of a grid and the like.

The carrier substrate is subsequently metallized over the entire area.

This layer is comprised of a metal, a metal compound, or an alloy. Suitable metal layers are layers of Al, Cu, Fe, Ag, Au, Cr, Ni, Zn and the like. Suitable metal compounds are for example oxides or sulfides of metals, in particular TiO₂, Cr oxides, ZnS, ITO, ATO, FTO, ZnO, Al₂O₃ or silicon oxides. Suitable alloys are for example Cu—Al alloys, Cu—Zn alloys and the like.

This functional layer can be applied with known methods, for example by vapor deposition, sputtering, printing (gravure printing, flexographic printing, screen printing, digital printing and the like). The thickness of the functional layers is 0.001 to 50 μm, preferably 0.1 to 20 μm.

The metallized carrier substrate is subsequently heated, such that the applied digital printing ink melts. Heating can take place by guidance over a heatable cylinder, by guidance through a drying tunnel, heating by means of an IR radiator and the like.

The liquified digital printing ink, together with the metallic layer superjacent in these regions, is subsequently removed by mechanical action, for example with a stripping roll, of a textile area-measured material and the like or through ultrasonic treatment.

In this way individualized partially metallized carrier substrates can be produced in simple manner.

Onto the carrier substrates further functional layers with optical, optically active, magnetically and/or electrically conductive properties can optionally also be applied or be already present on it before the individualized partial metallization.

The carrier substrates produced according to the invention, optionally after being appropriately cut to size (for example cut into filaments, bands, strips, patches or other formats), are therefore utilized as security features in data media, in particular security documents, such as passes and identification cards, cards, bank notes or labels, seals and the like, however also in packaging material for sensitive goods, such as pharmaceuticals, cosmetics, data media, electronic structural parts and the like.

1-11. (canceled)

12. Method for the production of a metallized carrier substrate, which comprises:
a) applying a printing ink with melt-on capability onto part of a carrier substrate, by a digital printing method,
b) then metallizing the carrier substrate over an entire surface, including said printing ink, to form a metallized layer thereover,
c) heating the metallized carrier substrate, whereupon the printing ink with melt-on capability applied in a) is melted, and then
d) removing the melted printing ink together with the superjacent metallized layer through mechanical action or by means of ultrasonic treatment.

13. Method as claimed in claim 12, wherein in a) the printing ink with melt-on capability is applied individualized.

14. Method as claimed in claim 12, wherein the printing ink with melt-on capability is transparent.

15. Method as claimed in claim 12, wherein the printing ink with melt-on capabiltiy melts in the range of 90 to 160° C.

16. Method as claimed in claim 12, wherein the carrier substrate, comprises synthetic sheet, metal sheet, paper, composite with paper, non-woven or woven textile.

17. Method as claimed in claim 12, wherein the metallization forms a metallized layer of metal, a metal compound or an alloy.

18. Method as claimed in claim 17, wherein the metallized layer comprises Al, Cu, Fe, Ag, Au, Cr, Ni, Zn, a sulfide or oxide of these metals.

19. Method according to claim 17, wherein the metallized layer comprises TiO₂, Cr oxide, ZnS, ITO, ATO, FTO, ZnO, Al₂O₃ or a Cu—Al or Cu—Zn alloy.

20. Method as claimed in claim 12, wherein the removal of the melted printing ink is carried out in d) with a stripping roll or a textile area-measured material or through ultrasonic treatment.

21. Security elements comprising a carrier substrate produced according to claim 12.

22. Packaging elements or packaging sheets comprising a carrier substrate produced according to claim 12.
